(19) United States
(12) Patent Application Publication
(10) Pub. No.: US 2023/0311230 A1
(43) Pub. Date: Oct. 5, 2023

(54) CANCELLATION OF THE EFFECTS OF PRIMARY VOLTAGE VARIATIONS

(71) Applicant: ESAB AB, Gothenburg (SE)

(72) Inventor: Björn Daniel Landin, Mölndal (SE)

(21) Appl. No.: 17/712,265

(22) Filed: Apr. 4, 2022

(51) Int. Cl. B23K 9/10; H02M 3/335; H02M 1/08

(52) U.S. Cl. CPC B23K 9/1062; H02M 3/335; H02M 1/08

(57) ABSTRACT

A method for cancelling the effects of variation of primary voltage supplied to a welding power supply includes receiving a mains voltage at the welding power supply, rectifying the mains voltage to obtain a rectified voltage, applying the rectified voltage to an input of a pulse wave modulated (PWM) controlled inverter, detecting a value of the rectified voltage, setting a maximum duty cycle for the PWM controlled inverter based on the value of the rectified voltage, and operating the PWM controlled inverter in accordance with the maximum duty cycle for the PWM controlled inverter. The maximum duty cycle may also be set according to a core size or area of a main transformer of the welding power supply.

### FIELD OF THE DISCLOSURE

The present disclosure relates generally to welding and cutting equipment and, more particularly, to a power supply for welding and cutting equipment.

### BACKGROUND OF THE DISCLOSURE

Inverter-based welding and cutting power supplies typically control the power in a welding operation by dynamically adjusting the pulse width modulation of an inverter circuit based on feedback representative of an arc voltage and/or current during a welding/cutting operation.

According to one approach, input power, such as AC power from mains or a generator, is rectified and conditioned to supply DC power at a constant, regulated voltage (often called the “DC bus”) to the input of an inverter circuit. The inverter circuit comprises a set of high-speed semiconductor switching devices (e.g., IGBTs or MOSFETS) that are switched on and off at a high frequency to create a high-frequency AC waveform that is supplied to a primary side of a main transformer. The main transformer converts the voltage and current of the input AC signal from the inverter circuit to desired voltage and current levels suitable for the welding/cutting operation. The resulting AC signal generated by the main transformer, supplied by a secondary side of the transformer, is then rectified to supply power to, e.g., a welding torch. The aforementioned approach of providing a stabilized primary DC voltage (i.e., a regulated DC bus having a voltage controlled to a specific level regardless of the input voltage level) is a costly solution.

Another approach is to supply an unregulated input voltage to the welding inverter. However, worldwide, AC mains voltages vary greatly, meaning that the rectified voltage supplied to the welding inverter will also vary widely. For example, AC mains voltages, worldwide, span from 220 VAC_RMS to 575 VAC_RMS, and a resulting rectified voltage seen by the welding inverter will thus span from 310 VDC to 810 VDC. It is noted that the rectifier charges DC bus capacitors to a peak voltage of the incoming mains voltage waveform, and thus the range of the rectified DC voltage is significantly higher than the RMS voltage of the incoming AC mains power source.

Since the output of the main transformer is dependent on the input voltage, the wide input voltage range will result in a wide output variation from the inverter/transformer combination. This means that the output welding voltage and current profile will change, perhaps detrimentally, as a result of different mains input voltages.

### SUMMARY OF THE DISCLOSURE

A method for cancelling the effects of variation of primary voltage supplied to a welding power supply is described and includes receiving a mains voltage at the welding power supply, rectifying the mains voltage to obtain a rectified voltage, applying the rectified voltage to an input of a pulse wave modulated (PWM) controlled inverter, detecting a value of the rectified voltage, setting a maximum duty cycle for the PWM controlled inverter based on the value of the rectified voltage, and operating the PWM controlled inverter in accordance with the maximum duty cycle for the PWM controlled inverter. The maximum duty cycle may also be set according to a core size or area of a main transformer of the welding power supply.

A welding power supply that operates consistent with the described method is also described.

### BRIEF DESCRIPTION OF THE DRAWINGS

By way of example, embodiments of the disclosed systems and methods will now be described, with reference to the accompanying drawings, in which:

FIG. 1 is a block diagram of a welding machine, including a controller having maximum duty cycle setting control logic, in accordance with an example embodiment.

FIG. 2 is a graph showing a duty cycle versus DC bus voltage curve that shows the effects of maximum duty cycle setting control logic, in accordance with an example embodiment.

FIG. 3 is a graph showing two curves illustrating how welding current rise time is effectively the same for two different DC bus voltages, which have been acted upon by maximum duty cycle setting control logic, according to an example embodiment.

FIG. 4 is flowchart depicting a series of operations for operating a welding power supply including maximum duty cycle setting control logic, according to an example embodiment.

FIG. 5 is a graph showing a duty cycle versus DC bus voltage curve that shows the effects of maximum duty cycle setting control logic taking into account main transformer core area or size, in accordance with an example embodiment.

FIG. 6 is flowchart depicting a series of operations for operating a welding power supply including maximum duty cycle setting control logic taking into account main transformer core area or size, according to an example embodiment.

### DETAILED DESCRIPTION

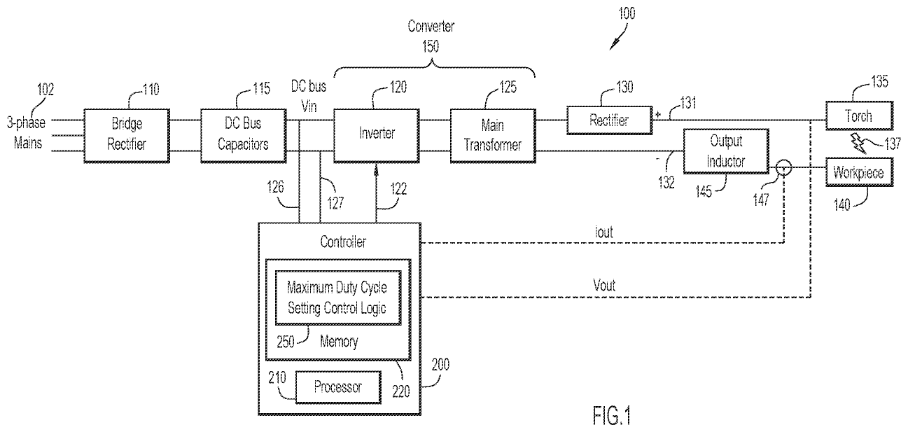

FIG. 1 is a block diagram of a welding machine, including a controller 200 having maximum duty cycle setting control logic 250, in accordance with an example embodiment. As shown in the figure, a three-phase mains AC input signal 102 is supplied to a bridge rectifier 110. A single phase input may also be employed with the embodiments described herein. Bridge rectifier 110 is in communication with DC bus capacitors 115, which smooth/filter the output of bridge rectifier 110 to provide a filtered version of the output of the bridge rectifier 110. It is noted that bridge rectifier 110 charges the DC bus capacitors 115 to the peak voltage of the incoming waveform, which may be significantly higher than the RMS voltage value of the sinusoidal AC mains power source. Bridge rectifier 110 and DC bus capacitors 115 supply a DC bus voltage to inverter 120. Inverter 120 includes a plurality of semiconductor switches (not shown) that are switched on and off by one or more gate drive or PWM signals 122 supplied by controller 200. The semiconductor switches chop the DC bus signal at a predetermined frequency to generate an AC signal that is supplied to main transformer 125. A higher frequency, compared to the mains frequency, enables main transformer 125 to be smaller, and thus lighter and less costly.

Main transformer 125 transforms the voltage-current profile (i.e., power) received from inverter 120 into a voltage-current profile (power) that is suitable for welding or cutting (typically a lower voltage than the voltage provided by the mains, and higher current than the current supplied by mains). The power suitable for welding (or cutting) is supplied to rectifier 130. In one possible use case, an output 131 of rectifier 130 (positive welding power) is supplied to a torch 135. When powered by the power supply 100, torch 135 generates an arc 137 between itself, or a wire electrode associated therewith, and a workpiece 140. The electrical circuit is completed back to the power supply 100 on the negative terminal 132 via output inductor 145. A combination of inverter 120 and main transformer 125 main be referred to herein as a “converter” 150.

Though not shown in the figure, other components for particular welding processes (e.g., MIG, TIG, stick, etc.) may be included in the overall system depicted, such as a wire feeder, inert gas supply, etc.

The switching frequency and ON/OFF ratio (or duty cycle, D) of the semiconductor switches in inverter 120 are controlled by controller 200 to provide a regulated output voltage and/or current of the welding type power supply. Controller 200 includes a processor 210, and a memory 220 for storing logic, instructions, computer code, etc., that is implemented to perform the functionality described herein. Maximum duty cycle setting control logic 250 may be stored in memory 220.

A current sensor 147 provides a feedback signal indicative of the output current (Tout). Voltage feedback signal Vout may also be provided to controller 200. Vout may be representative of a direct output of the power supply 100, and/or may be representative of “true” arc voltage, measured closer to, or at, the torch 135 itself. By monitoring Tout and Vout, controller 200 can adjust PWM signals 122 to enable more, or less, power to be transformed through transformer 125 to maintain, e.g., a constant current or constant voltage, or a particular desired modulated waveform, at the weld zone, i.e., where arc 137 interacts with workpiece 140.

Controller 200 may also provide other functions such as monitoring thermal sensors, controlling cooling fans, and receiving and sending various status and control signals to other circuits and control mechanisms. Controller 200 also preferably allows a user to select and to control a welding process, and may provide various signals, indicators, controls, meters, computer interfaces, etc., to allow the user to set up and configure the power supply 100 as required for a given welding process.

As shown in FIG. 1, and in accordance with an embodiment, controller 200 not only monitors the output of power supply 100, but also monitors a, non-regulated, input voltage on the DC bus via connections 126, 127, i.e., an input voltage to converter 150. As will be explained below, controller 200, and particularly maximum duty cycle setting control logic 250, controls the maximum duty cycle of the semiconductor switches in inverter 120, in response to the detected, non-regulated, input voltage to converter 150.

Specifically, the relationship between input voltage Vin (i.e., DC bus voltage supplied to converter 150) and gain G(s) is given as:

G(s)=Vout/Vin=D/N, where D=inverter duty cycle, and N=transformer ratio, i.e., a ratio between the primary winding and the secondary winding of the transformer or turns ratio (Nprim/Nsec).

By re-arranging terms, it can be seen that D=Vout*N/Vin.

As those skilled in the art will appreciate, for a given use case, Vout will be a desired set voltage, e.g., 40 volts, and thus may be considered fixed for a particular selected welding or cutting process, and N is fixed. As such, once Vin is detected, maximum duty cycle setting control logic 250 is configured to calculate a maximum duty cycle (Dmax) beyond which the semiconductor switches are not permitted to operate.

By setting a maximum duty cycle, it is possible to set a maximum gain of the converter 150. This will result in a uniform maximum gain of the converter 150 over the total likely input voltage span. This enables a consistent and repeatable welding result for any input voltage within the total likely input voltage span. The value Dmax may be stored in a location that is accessible to maximum duty cycle setting control logic 250, such as in memory 220, as needed.

The following are several examples of Dmax calculations for a welding machine that might be exposed to mains input voltages of 400 VAC-575 VAC:

(1) Low input voltage, 400 VAC

Vout=65V

Transformer ratio (N)=7

Input Voltage=400 VAC=>DC bus (Vin)=560 VDC

Max Duty cycle=[Vout*N/U_DC_bus] 65*7/560=81% (where U_DC_bus=Vin)

(2) Medium input voltage, 480 VAC

Vout=65V

Transformer ratio (N)=7

Input Voltage=480 VAC=>DC bus=670 VDC

Max Duty cycle=65*7/670=68%

(3) High input voltage, 575 VAC

Vout=65V

Transformer ratio (N)=7

Input Voltage=575 VAC=>DC bus=810V

Max Duty cycle=65*7/810=56%

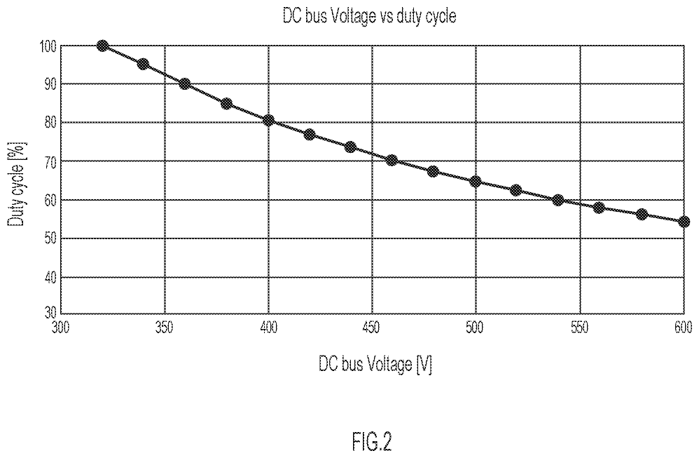

Thus, as those skilled in the art will appreciate, and as shown in FIG. 2, as the DC bus voltage increases, the maximum allowable duty cycle of the inverter can be reduced, such that a steady output voltage and current profile (power) can be output from the power supply 100 regardless of the input voltage value, within a predetermined range.

Detecting the DC bus voltage may be performed during a startup procedure of power supply 100, or may be performed continuously or periodically, while power supply 100 is powered on such that Dmax may be re-set with a new value according to a newly-detected Vin (DC bus voltage).

Once Dmax is calculated, and available to maximum duty cycle setting control logic 250, it can be used in at least two ways. First, Dmax can be used as a “cap” on the allowed duty cycle of the semiconductor switches in inverter 120, such that where controller 200, in view of voltage and current sensed values on the output side of power supply 100, calls for a duty cycle greater than Dmax, the duty cycle of PWM signals 122 will never be greater than Dmax. That is, the ON periods of the PWM signals 122 will not be permitted to exceed the Dmax value.

In a second, but not mutually exclusive way, Dmax can be used as a scaling or weighting factor on all duty cycle values called for by controller 200. For example, assuming Dmax is calculated to be 56%, then any value called for by controller 200 may be scaled, e.g., multiplied, by 0.56. In this way, the duty cycle may be smoothed and reduced or dampened across its entire possible range, rather than only being capped at a high end.

Thus, according to the described technique, the input voltage Vin (the DC bus voltage) is measured and an appropriate value for the maximum duty cycle Dmax is calculated in order to set a maximum gain of the system that will result in a uniform maximum gain of the weld inverter for the total likely input voltage span. This enables a consistent and repeatable welding result for any input voltage. In other words, for high input voltages Vin, the maximum duty cycle Dmax of the inverter 120 will be lower than the maximum duty cycle Dmax for a lower input voltage in order to obtain the same maximum gain over the range of possible input voltages.

In short, the maximum duty cycle of the inverter 120 is set based on the voltage level of an unregulated input voltage (i.e., merely the rectified, and perhaps filtered, AC input power, without prior treatment such as a boost power factor correction (PFC) stage and/or regulator).

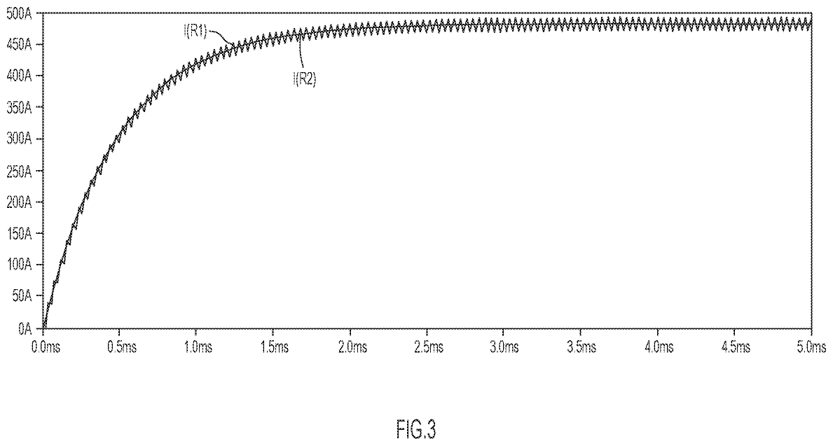

This approach also has the effect of making the output current ramp the same across a range of input voltages. See, for example, FIG. 3, which shows two current curves, I(R1) and I(R2). For I(R2), Vin=350 VDC with a full duty cycle, and for I(R1), Vin=700 VDC with a limited duty cycle. As can be seen from the two curves, di/dt is effectively the same for both input voltages.

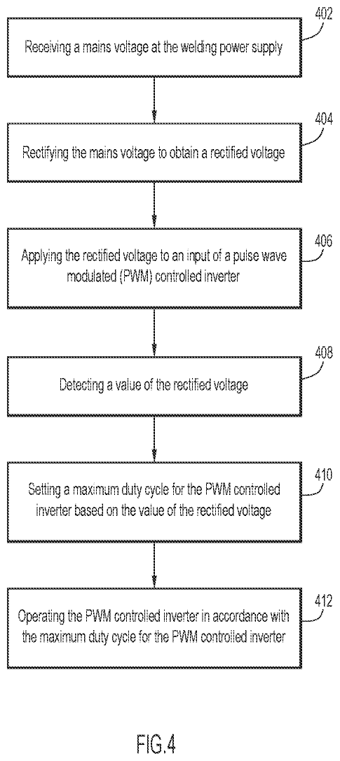

FIG. 4 is flowchart depicting a series of operations for operating a welding power supply, including maximum duty cycle setting control logic taking into account DC bus voltage, according to an example embodiment. The operations may be performed in a welding power supply. The operations may include, at 402, receiving a mains voltage at the welding power supply. At 404, an operation includes rectifying the mains voltage to obtain a rectified voltage. At 406, an operation includes applying the rectified voltage to an input of a pulse wave modulated (PWM) controlled inverter, At 408, an operation includes detecting a value of the rectified voltage. At 410, an operation includes setting a maximum duty cycle for the PWM controlled inverter based on the value of the rectified voltage. And, at 412, an operation includes operating the PWM controlled inverter in accordance with the maximum duty cycle for the PWM controlled inverter.

This same approach can be helpful in connection with selecting an appropriate core size for main transformer 125. Specifically, in a system with unregulated input voltage, i.e., rectified AC mains, which around the world might span 220 VAC_RMS to 575 VAC_RMS, the rectified voltage seen by the welding inverter will span from 310 VDC to 810 VDC.

The main transformer ratio is configured in view of the lowest likely input voltage in order to achieve sufficient welding voltage and thereby welding performance. The core size of the main transformer 125 is set by the voltage—time area, i.e., the highest input voltage likely to be experienced according to Ac=Vin_max*Dmax/B_core*N, where Ac=effective core area, Dmax=maximum duty cycle, B_core=peak flux density, and N=transformer ratio.

Thus, to design for a maximum potential voltage from AC mains, it is necessary to have a relatively larger transformer core, increasing size and cost of the component.

As an alternative, and in accordance with an embodiment, if a more reasonably-sized transformer core is employed, i.e., one that may not be able to handle the highest potential DC bus voltages, a method includes, in operation of power supply 100, measuring Vin and continuously calculating an appropriate value for Dmax in order not to have fixed voltage—time area over the main transformer 125, regardless of input voltage. In other words, maximum duty cycle setting control logic 250 may be further configured to perform the following calculation: Vin*Dmax=Ac*B_core*N

The core area (Ac) or size is fixed in the design, and thus for any DC bus input voltage (Vin) a maximum allowed value of the duty cycle (Dmax) can be calculated by: Dmax=Ac*B_core*N/Vin. Maximum duty cycle setting control logic 250 then uses Dmax to limit the duty cycle as the DC bus input voltage Vin exceeds a predetermined threshold. This approach allows for optimizing the transformer design, making it smaller and more cost effective.

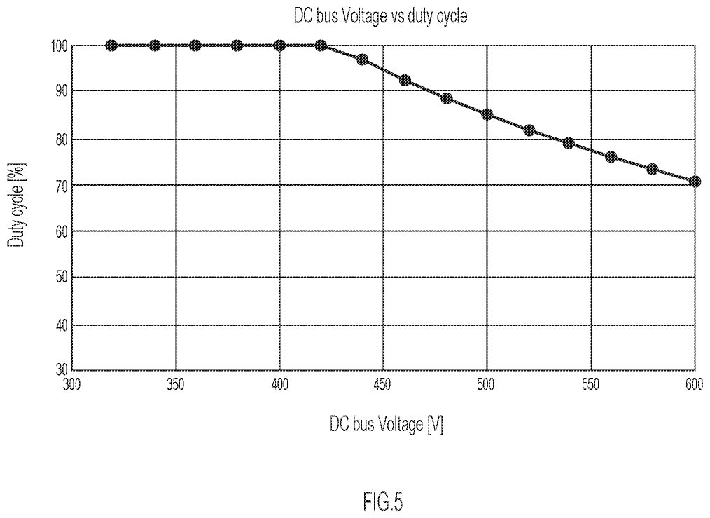

The following are several examples of Dmax calculations to compensate for a smaller main transformer core, where main transformer 125 might be exposed to mains input voltages of 400 VAC-575 VAC In the examples below the following is assumed: Ac*B_core*N=Transformer Constant=0.015 and a period time, T, of 25 us. Reference may also be made to FIG. 5, which shows a curve of duty cycle versus DC bus input voltage in the context of compensating for a relatively small transformer core.

(1) Low input voltage, 400 VAC

DC bus=560 VDC

Max duty cycle=0.015/560/25*E−6=107%, which means no duty cycle limit is needed.

(2) Medium input voltage, 480 VAC

DC bus=670 VDC

Max duty cycle=0.015/670/25*E−6=90%

(3) High input voltage, 575 VAC

DC bus=810 VDC

Max duty cycle=0.015/810/25*E−6=74%

Thus, as can be seen in FIG. 5, as the DC bus input voltage increases beyond some threshold value, namely a value above which the main transformer core might saturate, i.e., a peak flux density of the core is reached, the core no longer operates efficiently, and the duty cycle of the inverter 120 is therefore controlled by maximum duty cycle setting control logic 250 to reduce the duty cycle thereby reducing the voltage-time area for the power being applied to the main transformer 125, thereby keeping the flux density in the core to an acceptable level.

It is noted that the Dmax calculation taking into account transformer core size may be “ORed” with the Dmax calculation that was discussed with respect to better controlling the gain of converter 150. In one implementation, the lower of the two calculated values may be selected to control the PWM signals 122 supplied to inverter 120.

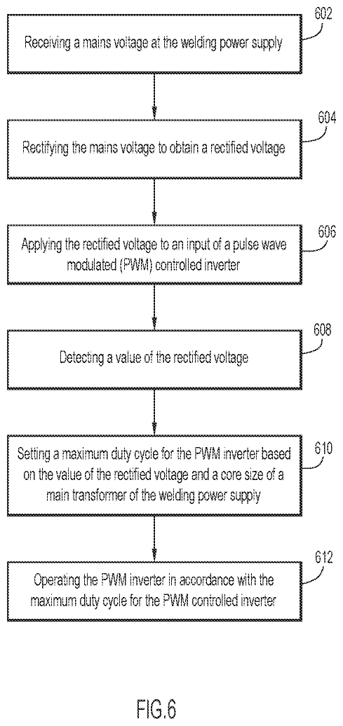

FIG. 6 is flowchart depicting a series of operations for operating a welding power supply including maximum duty cycle setting control logic taking into account main transformer core area or size, according to an example embodiment. The operations may be performed in the welding power supply. The operations may include, at 602, receiving a mains voltage at the welding power supply. At 604, an operation includes rectifying the mains voltage to obtain a rectified voltage. At 606, an operation includes applying the rectified voltage to an input of a pulse wave modulated (PWM) controlled inverter. At 608, an operation includes detecting a value of the rectified voltage. At 610, an operation includes setting a maximum duty cycle for the PWM controlled inverter based on the value of the rectified voltage and a core size, or area, of a main transformer of the welding power supply. And, at 612, an operation includes operating the PWM controlled inverter in accordance with the maximum duty cycle for the PWM controlled inverter.

The above description is intended by way of example only. Various modifications and structural changes may be made therein without departing from the scope of the concepts described herein and within the scope and range of equivalents of the claims.

What is claimed is:

1. A method performed in a welding power supply, comprising:
receiving a mains voltage at the welding power supply;
rectifying the mains voltage to obtain a rectified voltage;
applying the rectified voltage to an input of a pulse wave modulated (PWM) controlled inverter;
detecting a value of the rectified voltage;
setting a maximum duty cycle for the PWM controlled inverter based on the value of the rectified voltage; and
operating the PWM controlled inverter in accordance with the maximum duty cycle for the PWM controlled inverter.

2. The method of claim 1, further comprising controlling the duty cycle for the PWM controlled inverter based on feedback received from an output of the welding power supply.

3. The method of claim 1, further comprising applying an output of the inverter to a primary winding of a main transformer of the welding power supply.

4. The method of claim 3, further comprising setting the maximum duty cycle of the PWM controlled inverter based on a ratio of turns between the primary winding and a secondary winding of the main transformer.

5. The method of claim 3, further comprising setting the maximum duty cycle of the PWM controlled inverter based on a desired output voltage of the welding power supply.

6. The method of claim 3, further comprising setting the maximum duty cycle of the PWM controlled inverter based on a size or area of a core of the main transformer.

7. The method of claim 1, further comprising sensing the rectified voltage during a startup phase of the welding power supply.

8. The method of claim 1, further comprising sensing the rectified voltage during on-going operations of the welding power supply and re-setting the maximum duty cycle for the PWM controlled inverter based on a new value of the rectified voltage.

9. The method of claim 1, further comprising storing a value of the maximum duty cycle in a location accessible to a pulse wave modulation controller that controls the PWM controlled inverter.

10. The method of claim 1, further comprising filtering the rectified voltage with a capacitor to obtain a filtered version of the rectified voltage, and detecting the value of the rectified voltage based on the filtered version of the rectified voltage.

11. A power supply, comprising:
a rectifier that receives a mains voltage and outputs a rectified voltage;
a pulse wave modulated (PWM) controlled inverter arranged to be powered by the rectified voltage; and
a controller that sets a maximum duty cycle for the PWM controlled inverter based on a detected value of the rectified voltage.

12. The power supply of claim 11, wherein the power supply is arranged to provide at least one of power for welding or for cutting.

13. The power supply of claim 11, wherein the controller is arranged to control the duty cycle for the PWM controlled inverter based on feedback received from an output of the power supply.

14. The power supply of claim 11, further comprising a main transformer having a primary winding and a secondary winding, wherein an output of the PWM controlled inverter is supplied to the main transformer, and the controller is arranged to set the maximum duty cycle of the PWM controlled inverter based on a ratio of turns between the primary winding and the secondary winding of the main transformer.

15. The power supply of claim 14, wherein the controller is arranged to set the maximum duty cycle of the PWM controlled inverter based on a desired output voltage of the power supply.

16. The power supply of claim 14, wherein the controller is arranged to set the maximum duty cycle of the PWM controlled inverter based on a size or area of a core of the main transformer.

17. The power supply of claim 11, wherein the controller senses the rectified voltage during a startup phase of the power supply.

18. The power supply of claim 11, wherein the controller senses the rectified voltage during on-going operations of the power supply.

19. A power supply for welding or cutting, comprising:
a rectifier that receives a mains voltage and outputs a rectified voltage;
a pulse wave modulated (PWM) controlled inverter arranged to be powered by the rectified voltage; and
a controller that controls a duty cycle of the PWM controlled inverter based on at a non-regulated version of the mains voltage.

20. The power supply for welding or cutting of claim 19, further comprising a main transformer having a primary winding and a secondary winding, wherein an output of the PWM controlled inverter is supplied to the main transformer, and the controller further controls the duty cycle of the PWM controlled inverter based on a ratio of turns between the primary winding and the secondary winding of the main transformer.
